(19) United States
(12) Patent Application Publication
(10) Pub. No.: US 2024/0130327 A1
(43) Pub. Date: Apr. 25, 2024

(54) TRACKING TAGS FOR ANIMAL TRACKING

(71) Applicant: MICROTRAKS, INC., San Antonio, TX (US)

(72) Inventors: Michael Fregeau, San Antonio, TX (US); Patrick Herron, Austin, TX (US); Michael Maziarz, Wilbraham, MA (US); Francisco Quiros, Amherst, MA (US)

(73) Assignee: MICROTRAKS, INC., San Antonio, TX (US)

(21) Appl. No.: 18/404,613

(22) Filed: Jan. 4, 2024

Related U.S. Application Data
(63) Continuation-in-part of application No. 18/305,780, filed on Apr. 24, 2023.
Application No. 18/305,780 is a continuation of application No. 17/533,494, filed on Nov. 23, 2021, now Pat. No. 11,653,628.
(60) Provisional application No. 63/478,481, filed on Jan. 4, 2023.

(51) Int. Cl. A01K 11/00; A01K 29/00; G06K 19/07; G06K 19/077; H04W 4/80

(52) U.S. Cl. CPC A01K 11/006; A01K 29/005; G06K 19/071; G06K 19/0723; G06K 19/07762; G06K 19/07786; H04W 4/80

(57) ABSTRACT

Tracking tags for animal tracking, methods for animal tracking with tracking tags, and systems for animal tracking. The tracking tag includes a Bluetooth Low Energy (BLE) module, a Global Navigation Satellite System (GNSS) module, and a controller. The controller is configured to detect, using the BLE module, when an animal is located within a zone defined by one or more repeater devices. The controller is also configured to deactivate the GNSS module when the animal is detected as being within the zone. The controller is further configured to activate the GNSS module when the animal is not detected as being within the zone.

### CROSS-REFERENCE TO RELATED APPLICATIONS

This application claims priority to and the benefit of U.S. Provisional Application No. 63/478,481 filed Jan. 4, 2023, titled “AUTONOMOUS SENSOR BASED TRACKING SYSTEM FOR ANIMALS AND LIVESTOCK” (Attorney Docket No. 88327-500) the entire disclosure of which is hereby incorporated by reference for all purposes. This application also claims priority to and is a continuation-in-part of U.S. Utility patent application Ser. No. 18/305,780 filed Apr. 24, 2023, titled “BLUETOOTH LOW ENERGY TRACKING TAGS FOR LIVESTOCK TRACKING” (Attorney Docket No. 88327-402), which claims priority to and is a continuation of U.S. Utility patent application Ser. No. 17/533,494 filed Nov. 23, 2021 (now U.S. Pat. No. 11,653,628), titled “BLUETOOTH LOW ENERGY TRACKING TAGS FOR CATTLE TRACKING” (Attorney Docket No. 88327-401), the entire disclosures of which are hereby incorporated by reference for all purposes.

### BACKGROUND

Current electronic identification methods of cattle and animals rely on traditional radio frequency devices. These devices require a wand to be passed over the ear tag of the animal. This requires the wand holder to be in very near proximity to the animal, which requires the animal to be held, corralled, or trapped in place to allow for manual scanning of the tag. Due to the cumbersome process to scan tags, this process is usually performed at veterinary checks, or when animals are moved to a new location (for example, between farms, ranches, or saleyards).

New technologies have evolved and exist in the marketplace that have changed the way data is collected from animals. Ear tags have become smarter, with longer range communication capability, which allow for easier collection of data in remote areas. But they still do not provide the complete solution of animal information that one needs to successfully monitor livestock and animals remotely. They typically also need to have a specific “ear-tag” design to incorporate the technology into. The technology is not able to be easily incorporated into different types of ear-tags.

### SUMMARY

The present disclosure provides a tracking tag for animal tracking. The tracking tag includes, in one implementation, a Bluetooth Low Energy (BLE) module, a Global Navigation Satellite System (GNSS) module, and a controller. The controller is configured to detect, using the BLE module, when an animal is located within a zone defined by one or more repeater devices. The controller is also configured to deactivate the GNSS module when the animal is detected as being within the zone. The controller is further configured to activate the GNSS module when the animal is not detected as being within the zone.

The present disclosure also provides a method for animal tracking with a tracking tag. The tracking tag includes, in one implementation, a BLE module and a GNSS module. The method includes detecting, using the BLE module, that an animal is located within a zone defined by a plurality of repeater devices. The method also includes deactivating the GNSS module when the animal is detected as being within the zone. The method further includes detecting, using the BLE module, that the animal is not located within the zone. The method also includes activating the GNSS module when the animal is detected as not being within the zone.

The present disclosure further provides a system for animal tracking. The system includes, in one implementations, a plurality of repeater devices and a tracking tag. The tracking tag includes a BLE module and a GNSS module. The tracking tag is configured to detect, using the BLE module, when an animal is located within a zone defined by one or more of the plurality of repeater devices. The tracking tag is also configured to deactivate the GNSS module when the animal is detected as being within the zone. The tracking tag is further configured to activate the GNSS module when the animal is not detected as being within the zone.

### BRIEF DESCRIPTION OF THE DRAWINGS

For a detailed description of example implementations, reference will now be made to the accompanying drawings in which:

FIG. 1 is a perspective view of an example of a tracking tag for animal tracking in accordance with some implementations;

FIG. 2A is a side view of an example of a tracking tag with a horizontally-oriented electronics enclosure in accordance with some implementations;

FIG. 2B is a side view of an example of a tracking tag with a vertically-oriented electronics enclosure in accordance with some implementations;

FIG. 3 is an exploded view of an example of an enclosure and a circuit board for a tracking tag in accordance with some implementations;

FIG. 4 is a side view of an example of an enclosure and a circuit board for a tracking tag in accordance with some implementations;

FIG. 5 is a cross-sectional view of the enclosure and the circuit board of FIG. 4 in accordance with some implementations;

FIG. 6 is a block diagram of an example of electronics included in a circuit board of a tracking tag in accordance with some implementations;

FIG. 7 is a block diagram on an example of a system for animal tracking in accordance with some implementations;

FIG. 8 is a flow diagram of an example of a method for animal tracking with a tracking tag in accordance with some implementations;

FIG. 9 is a block diagram of an example of a computer system in accordance with some implementations; and

FIG. 10 is a screen shot of an example of a graphical user interface for an animal tracking system in accordance with some implementations.

### DEFINITIONS

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection or through an indirect connection via other devices and connections.

In relation to electrical devices, whether stand alone or as part of an integrated circuit, the terms “input” and “output” refer to electrical connections to the electrical devices, and shall not be read as verbs requiring action. For example, a differential amplifier, such as an operational amplifier, may have a first differential input and a second differential input, and these “inputs” define electrical connections to the operational amplifier, and shall not be read to require inputting signals to the operational amplifier.

“Controller” shall mean, alone or in combination, individual circuit components, an application specific integrated circuit (ASIC), one or more microcontrollers with controlling software, a reduced-instruction-set computer (RISC) with controlling software, a digital signal processor (DSP), one or more processors with controlling software, a programmable logic device (PLD), a field programmable gate array (FPGA), or a programmable system-on-a-chip (PSOC), configured to read inputs and drive outputs responsive to the inputs.

The term “animal” shall mean a non-human animal. The term “animal” may refer to a livestock animal, but is not limited to cattle in a farming and agricultural environment. The term “animal” may also refer to a domesticated or wild animal (for example, a deer, a bison, a cat, a goat, or an elephant).

### DETAILED DESCRIPTION

The following discussion is directed to various implementations of the invention. Although one or more of these implementations may be preferred, the implementations disclosed should not be interpreted, or otherwise used, as limiting the scope of the present disclosure, including the claims. In addition, one skilled in the art will understand that the following description has broad application, and the discussion of any implementation is meant only to be exemplary of that implementation, and not intended to intimate that the scope of the present disclosure, including the claims, is limited to that implementation.

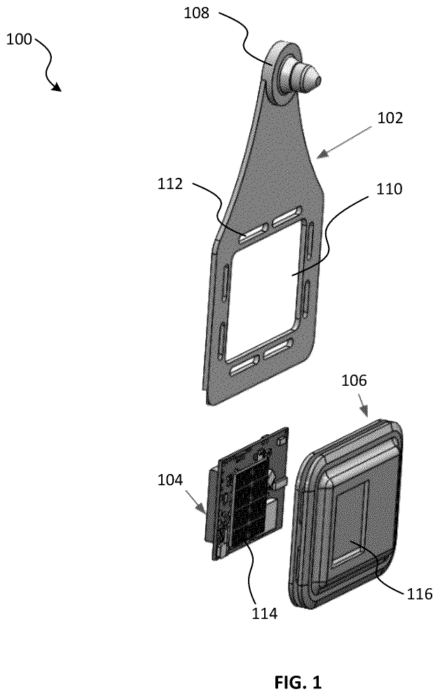

FIG. 1 is a perspective view of an example of a tracking tag 100 for animal tracking. The tracking tag 100 illustrated in FIG. 1 includes a base tag 102, a circuit board 104, and an enclosure 106. The tracking tag 100 illustrated in FIG. 1 is provided as one example of such a tag. The tracking tag 100 may include fewer components, additional components, or different components in different configurations than the tracking tag 100 illustrated in FIG. 1.

The base tag 102 includes an attachment device 108 configured to clip the tracking tag 100 to an ear of an animal. The attachment device 108 may include an elongated shaft assembly extending from the base tag 102 and piercing through the ear of an animal and connecting to a backing member attached at the rear of the ear.

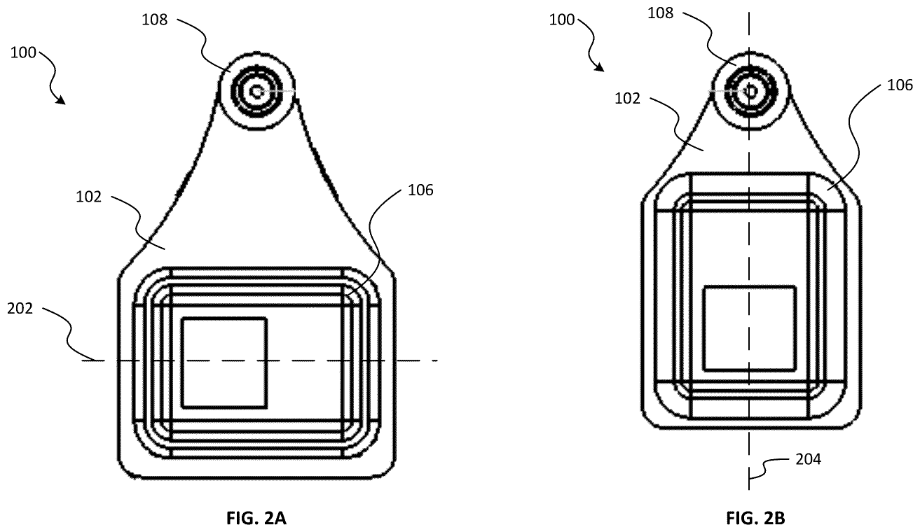

The base tag 102 also includes a hole 110 and a plurality of slots 112. The plurality of slots 112 align the enclosure 106 to remain inside the hole 110. In some implementations, the plurality of slots 112 are pill-shaped as illustrated in FIG. 1. In other implementations, the slots 112 may be circular-shaped, triangle-shaped, or square-shaped. The hole 110 and the plurality of slots 112 may be configured hold the enclosure 106 in different orientations relative to the base tag 102. For example, in some implementations, as illustrated in FIG. 2A, the hole 110 and the plurality of slots 112 may hold the enclosure 106 such that a longitudinal axis 202 of the enclosure 106 is aligned perpendicular to the attachment device 108. In other implementations, as illustrated in FIG. 2B, the hole 110 and the plurality of slots 112 may hold the enclosure 106 such that a longitudinal axis 204 of the enclosure 106 is aligned to intersect the attachment device 108. Positioning the enclosure 106 horizontal or vertical relative to the base tag 102 allows for a smaller tag to be used on smaller animals without causing damage to the ear, or the tag hanging too far down off the ear to increase the likelihood of entanglement with a tree, other animal, or a fence. The different orientations also allow for a solar collector 114 (which will be described in more detail below) to be positioned in a way that optimizes the solar effectiveness based on the animal's ear physiology.

The circuit board 104 includes different electronics (which will be described in more detail below). In some implementations, as illustrated in FIG. 1, the circuit board 104 includes the solar collector 114 configured to convert incident light into energy. The tracking tag 100 may be worn by an animal for nearly its entire life. Solar energy harvesting with the solar collector 114 helps address providing power to the electronics in the tracking tag 100.

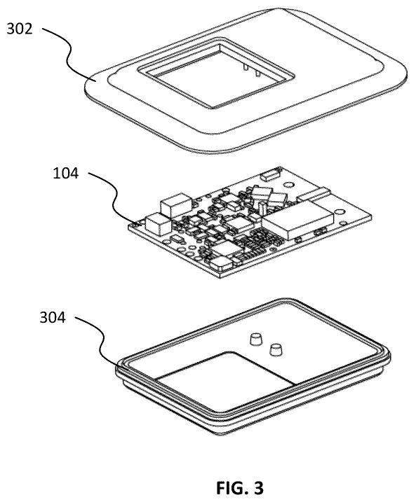

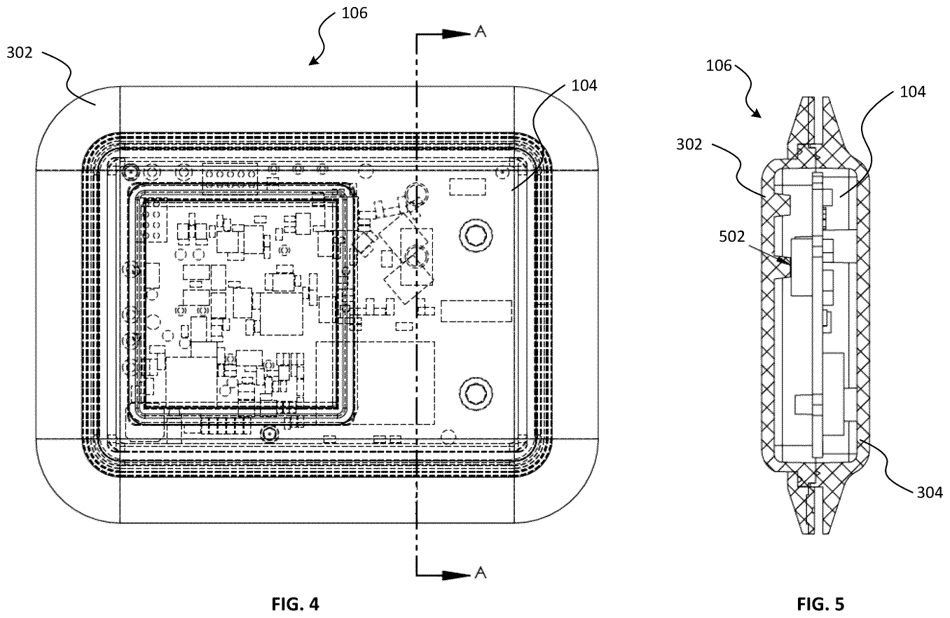

The enclosure 106 houses the circuit board 104. In some implementations, the enclosure 106 includes a window 116 positioned over the solar collector 114 as illustrated in FIG. 1. The window 116 may be formed of a polycarbonate material with a scratch resistant coating. In some implementations, as illustrated in FIG. 3, the enclosure 106 includes a front side 302 and a back side 304. As illustrated in FIG. 4, the front side 302 and the back side 304 of the enclosure 106 are configured to mate together to hold the circuit board 104. After enclosure, the front side 302 and the back side 304 of the enclosure 106 are assembled to the base tag 102. In some implementations, the front side 302 and the back side 304 of the enclosure 106 may be a loosely fitting assembly that can easily be taken apart. In other implementations, the front side 302 and the back side 304 of the enclosure 106 are permanently mated together, for example, using sonic welding. Using the tag assemblies disclose herein, the plurality of slots 112 can be cut into any tag existing in the marketplace. This can negate the necessity for a specific base tag design to be developed at costly development and tooling costs to allow for incorporation of the electronics assembly. The assembly of the front side 302, the back side 304, and the circuit board 104 can be integrated into existing tags in the marketplace. Further, the base tag 102 can be different preferred materials for animal comfort and wellness. Flexible softer materials may be used in the ear for prevention of discomfort, disease, and entanglement. The disclosed assembly type allows for the circuit board 104 to be protected from impact and environmental conditions without affecting the operation of the tracking tag 100 for animal health, the ear piercing, and the hanging portion. Furthermore, since the enclosure 106 may be removable from the base tag 102, when there is an issue with the base tag 102 (for example, the base tag 102 is defective, worn out, or broken), the enclosure 106 can be taken off the base tag 102 and applied to a new base tag.

In some implementations, the enclosure 106 is waterproof. FIG. 5 is a cross-sectional side view of the circuit board 104 and the enclosure 106 taken at line A in FIG. 4. In some implementations, the circuit board 104 includes a reset button 502. The reset button 502 may act as a master reset trigger for the tracking tag 100. As illustrated in FIG. 5, the reset button 502 may be positioned such that a portion of the enclosure 106 can be pushed to press the reset button 502. In this manner, the reset button 502 can be pressed without having to open the enclosure 106 and potentially expose the circuit board 104 to moisture.

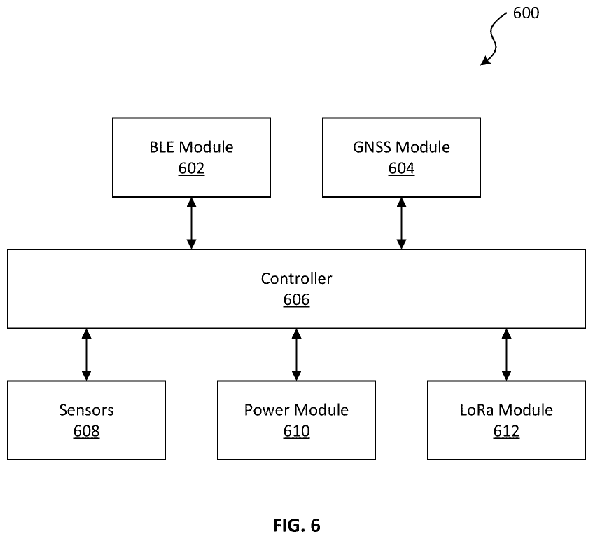

FIG. 6 is a block diagram of an example of electronics 600 included in the circuit board 104. The electronics 600 illustrated in FIG. 6 include a Bluetooth Low Energy module (i.e., BLE module 602), a Global Navigation Satellite System module (i.e., GNSS module 604), a controller 606, sensors 608, a power module 610, and a LoRa module 612. The electronics 600 illustrated in FIG. 6 is provided as one example of electronics that can be included in the circuit board 104. The circuit board 104 may include fewer components, additional components, or different components in different configurations than the electronics 600 illustrated in FIG. 6. For example, the circuit board 104 may also include a radio-frequency identification (RFID) chip.

The BLE module 602 is configured to interface with external Bluetooth readers and transmit a unique identifier of the tracking tag 100 (and other data) to the external Bluetooth readers via a Bluetooth Low Energy (BLE) transmission protocol. The BLE transmission protocol may include a BLE beaconing protocol. For example, in some implementations, the BLE module 602 transmits a unique identifier of the tracking tag 100 at a predetermined advertising interval (for example, every three seconds). The BLE module 602 may include a Bluetooth controller (for example, an NRF52805-CAAA microcontroller from Nordic Semiconductor) and an antenna (for example, a 2.4 gigahertz printed circuit board antenna).

The GNSS module 604 may include one or more devices for determining the location of an animal. For example, the GNSS module 604 may include a GPS (Global Positioning System) sensor.

The sensors 608 may include one or more sensors for detecting movement of an animal (for example, an accelerometer or a gyroscope). Alternatively, or in addition, the sensors 608 may include one or more sensors for detecting ambient environmental conditions near an animal (for example, a temperature sensor or a humidity sensor). In some implementations, the controller 606 is configured to determine one or more conditions of an animal based on data captured by the sensors 608. For example, the controller 606 may determine one or more conditions of an animal based on movement data of the animal captured by the sensors 608. As a specific example, the controller 606 may determine that an animal is in distress because the movement data of the animal indicates that the animal has fallen over and is unable stand up.

The power module 610 is configured to supply energy to the electronic components of the tracking tag 100. For example, the power module 610 may supply a low voltage to the BLE module 602 (for example, 3 Volts). In some implementations, the power module 610 includes a single battery. In other implementations, the power module 610 includes a plurality of batteries (or battery cells). In some implementations, the power module 610 is configured to monitor a charge level of the battery. For example, the power module 610 may measure the charge level of the battery and provide an indication of the charge level, for example, to the BLE module 602. The power module 610 may be configured to store energy collected by the solar collector 114 in a battery.

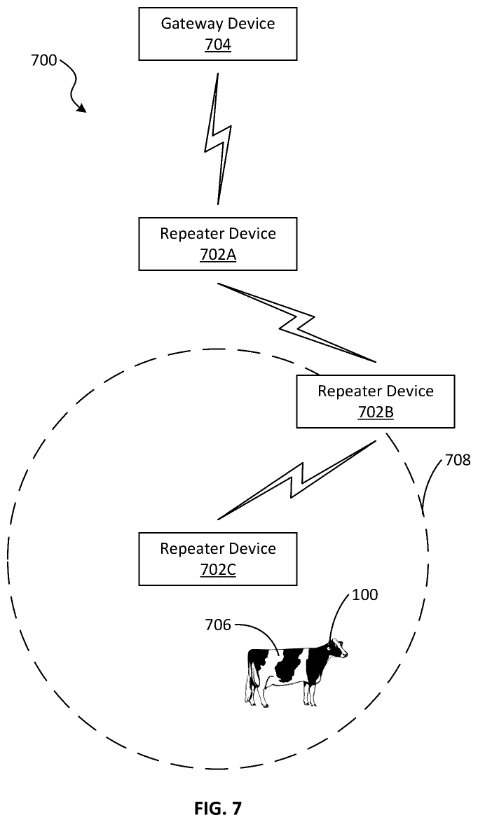

FIG. 7 is a block diagram on an example of a system 700 for animal tracking. The system 700 illustrated in FIG. 1 includes a plurality of repeater devices 702A, 702B, and 702C, a tracking tag 100, and a gateway device 704. For ease of understanding, the system 700 illustrated in FIG. 7 includes three repeaters device and one tracking tag. The system 700 can include more than three repeaters device and more than one tracking tag. Further, the system 700 may include multiple types of tags that work together to divide up the broadcast window into random slices so that the BLE can exist in a group minimizing the chance of collision.

The tracking tag 100 illustrated in FIG. 7 is coupled to an ear of a cow 706 (one example an “animal”). The BLE module 602 in the tracking tag 100 is able to transmit BLE data packets up to about thirty meters. In some situations, the cow 706 may be located much farther than thirty meters away from the gateway device 704. Each of the plurality of repeater devices 702A, 702B, and 702C are configured to receive BLE data packets and re-transmit received BLE data packets. In this manner, the plurality of repeater devices 702A, 702B, and 702C allow the tracking tag 100 to communicate with the gateway device 704. For example, the plurality of repeater devices 702A, 702B, and 702C may allow the BLE module 602 in the tracking tag 100 to communicate with a BLE module included in the gateway device 704. In some implementations, each of the plurality of repeater devices 702A, 702B, and 702C are also configured to receive LoRa data packets and re-transmit received LoRa data packets. Each of the plurality of repeater devices 702A, 702B, and 702C may include one or more processing devices, memory devices, data storage, and/or network interface devices.

The use of repeater devices has many benefits, including but not limited to, longer range and more energy, programmed to assist in forwarding tag packets of information back to gateways, act a brokers via BLE broadcasting to all tracking tags within a receiving distance, extend the range of a LoRa network, seed the tags with GPS ephemeris and almanac via BLE, save energy from the tags attached to animals, creating zones that saves animal tag energy by not having use GPS which consumes battery life rapidly. The repeater devices can also create electronic walls to indicate with animals leaves a fenced area. For example, a repeater device may be located at a desired position on a ranch to monitor livestock as they ingress and egress certain areas.

In some implementations, one or more of the plurality of repeater devices 702A, 702B, and 702C define a zone. For example, as illustrated in FIG. 7, the receiving range of the repeater device 702C defines a zone 708. When the cow 706 is located within the zone 708, the BLE module 602 in the tracking tag 100 is able to communicate with repeater device 702C.

In some implementations, artificial intelligence and machine learning is used to determine optimal placements for each of the plurality of repeater devices 702A, 702B, and 702C to provide the best coverage for the tags.

The gateway device 704 is configured to track the locations of animals. The gateway device 704 may include (or be communicably coupled) to a database that stores the identifications associated with the animals being monitored and various information pertaining to those animals, such as their identification number, name, date of birth, vaccine history, sire, location, medical history, place of origin, owner, ranch or farm name, and the like. In some implementations, the gateway device 704 may perform analysis based on the location of the animals determined via the data received from the plurality of repeater devices 702A, 702B, and 702C. For example, the gateway device 704 may determine an animal is near a hazard and provide an alert to indicate the same. In some implementations, the gateway device 704 may determine that an animal has left their designated roaming area and provide an alert. In other instances, the gateway device 704 may determine that an animal has a vaccine that is expired and needs to be re-administered based on the information stored in a database that is correlated with the data received from the plurality of repeater devices 702A, 702B, and 702C. The gateway device 704 may include one or more processing devices, memory devices, data storage, and/or network interface devices.

In some implementations, the gateway device 704 may be configured to detect (or predict) certain situations that would be of concern. For example, the gateway device 704 may use data from the sensors 608 in the tracking tag 100 to detect when an animal is distressed, left the herd, possibly been poached or shot, was mating, or has become deceased. In some implementations, the gateway device 704 may use one or more machine learning models to record sensor data (for example, movement, locations, interactions, and temperatures) to predict and notify the status of every animal in a network.

In some implementations, the tracking tag 100 can be programmed to be a mobile device which is attached to an animal, programmed to be a stationary device that acts as a repeater device, or attached to another animal as a repeater device.

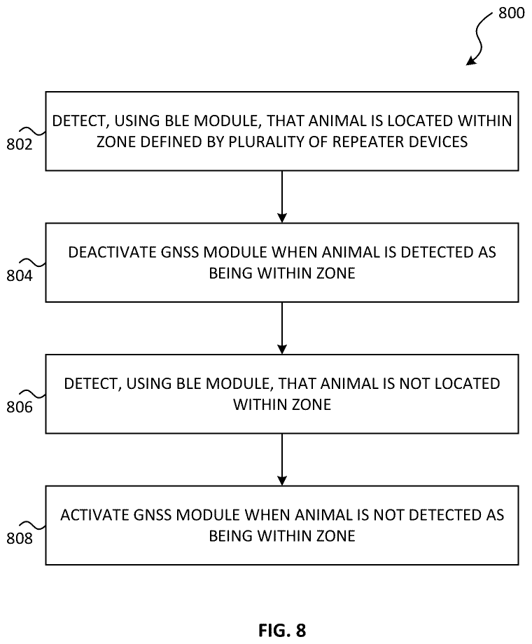

The GNSS module 604 consumes a lot of energy. Further, the gateway device 704 may be able to determine the location of the tracking tag 100 without using the GNSS module 604. For example, the gateway device 704 may determine that the tracking tag 100 is located within a transmission range of a repeater device when the BLE module 602 in the tracking tag 100 is communicating with the repeater device. Thus, in some implementations, to save power, the GNSS module 604 may be turned off (or put in a low-power mode) when location of the tracking tag 100 can be determined using the BLE module 602. To this end, FIG. 8 is a flow chart of an example of a method 800 for animal tracking with the tracking tag 100. In some implementations, the method 800 may be performed by one or more processing devices. For example, a manufacturing line in a manufacturing plant may include one or more computing devices storing computer instructions on one or more memory devices and executed by one or more processing devices. The computer instructions may cause the one or more processing devices to perform any combination of the operations described below when executed.

At block 802, the BLE module 602 detects that an animal is located with a zone defined by a plurality of repeater devices. For example, the zone may be the transmission range of a repeater device and the BLE module 602 may determine that the animal is located within the zone when the BLE module 602 is able to communicate directly with the repeater device. At block 804, the GNSS module 604 is deactivated when the animal is detected as being within the zone. For example, the controller 606 may send a shut-down signal to the GNSS module 604, send a go-to-sleep signal to the GNSS module 604, or stop supplying energy to the GNSS module 604 from the power module 610. At block 806, the BLE module 602 detects that the animal is not located within the zone. For example, the animal may no longer be located close enough to a repeat device to allow the BLE module 602 to communicate with the repeater device. At block 808, the GNSS module 604 is activated when the animal is not detected as being within the zone. For example, the controller 606 may send a turn-on signal to the GNSS module 604, send a wake-up signal to the GNSS module 604, or start the supplying energy to the GNSS module 604 from the power module 610.

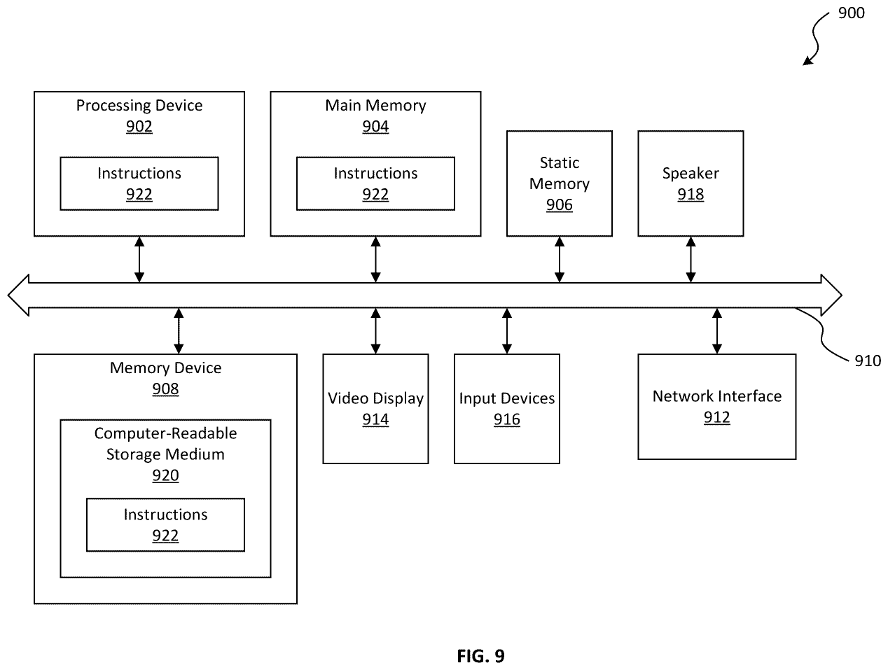

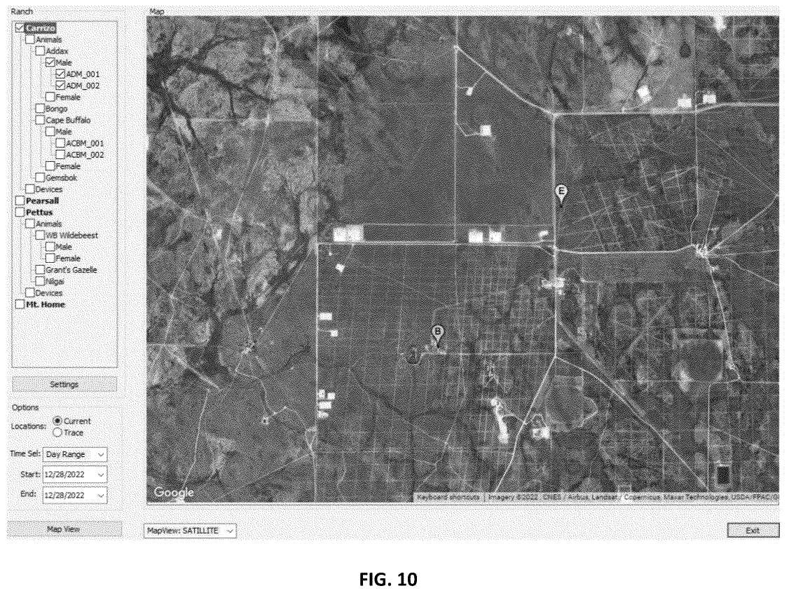

FIG. 9 is a block diagram of an example of a computer system 900. In some implementations, the computer system 900 may correspond to one of the plurality of repeater devices 702A, 702B, and 702C or the gateway device 704. The computer system 900 may be connected (for example, networked) to other computer systems in a LAN, an intranet, an extranet, or the Internet. The computer system 900 may operate in the capacity of a server in a client-server network environment. The computer system 900 may be a personal computer (PC), a tablet computer, a server, a wearable (for example, wristband), a set-top box (STB), a personal Digital Assistant (PDA), a mobile phone, a camera, a video camera, or any device capable of executing a set of instructions (sequential, parallel, or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 900 illustrated in FIG. 9 includes a processing device 902, a main memory 904 (for example, read-only memory (ROM), solid state drive (SSD), flash memory, dynamic random access memory (DRAM) such as synchronous DRAM (SDRAM)), a static memory 906 (e.g., solid state drive (SSD), flash memory, static random access memory (SRAM)), and a memory device 908, which communicate with each other via a bus 910.

Processing device 902 represents one or more general-purpose processing devices such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also be one or more special-purpose processing devices such as an application specific integrated circuit (ASIC), a field programmable gate array (FPGA), a digital signal processor (DSP), network processor, or the like. The processing device 902 is configured to execute instructions for performing any of the operations and steps discussed herein.

The computer system 900 may further include a network interface device 912. The computer system 900 also may include a video display 914 (for example, a liquid crystal display (LCD) or a cathode ray tube (CRT)), one or more input devices 916 (for example, a keyboard and/or a mouse), and one or more speakers 918 (for example, a speaker). In one illustrative example, the video display 914 and the input device(s) 916 may be combined into a single component or device (for example, an LCD touch screen).

The memory device 908 may include a computer-readable storage medium 920 on which the instructions 922 embodying any one or more of the methodologies or functions described herein are stored. The instructions 922 may also reside, completely or at least partially, within the main memory 904 and/or within the processing device 902 during execution thereof by the computer system 900. As such, the main memory 904 and the processing device 902 also constitute computer-readable media. The instructions 922 may further be transmitted or received over a communications network via the network interface device 912.

While the computer-readable storage medium 920 is shown in the illustrative examples to be a single medium, the term “computer-readable storage medium” should be taken to include a single medium or multiple media (for example, a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In some implementations, the gateway device 704 is configured to display Graphical User Interfaces (GUIs) to an end user to track animals, understand animal status, and create alarms as to whether action needs to be taken. For example, FIG. 10 is a screen shot of a GUI in which the locations of two tracked animals are shown on a map.

Consistent with the above disclosure, the examples of systems and methods enumerated in the following clauses are specifically contemplated and are intended as a non-limiting set of examples.

Clause 1. A tracking tag for animal tracking, comprising:
a Bluetooth Low Energy (BLE) module;
a Global Navigation Satellite System (GNSS) module; and
a controller configured to:
   detect, using the BLE module, when an animal is located within a zone defined by one or more repeater devices,
   deactivate the GNSS module when the animal is detected as being within the zone, and
   activate the GNSS module when the animal is not detected as being within the zone.

Clause 2. The tracking tag of any clause herein, further comprising one or more sensors for measuring movement data of the animal, wherein the controller is further configured to determine one or more conditions of the animal based on the movement data of the animal.

Clause 3. The tracking tag of any clause herein, further comprising:
a solar collector configured to convert incident light into energy; and
a power module configured to store the energy and provide the energy to the BLE module, the GNSS module, and the controller.

Clause 4. The tracking tag of any clause herein, further comprising an enclosure housing the BLE module, the GNSS module, the controller, the power module, and the solar collector, wherein the enclosure includes a window positioned over the solar collector, wherein the window includes a polycarbonate material with a scratch resist coating.

Clause 5. The tracking tag of any clause herein, further comprising an enclosure housing the BLE module, the GNSS module, and the controller, wherein the enclosure including a front side and a back side, wherein the front side is configured to mate with the back side to waterproof the enclosure.

Clause 6. The tracking tag of any clause herein, further comprising a reset button coupled to the controller, wherein the reset button is positioned within the enclosure such that the reset button is pressed when a portion of the enclosure is pressed.

Clause 7. The tracking tag of any clause herein, further comprising:
an enclosure housing the BLE module, the GNSS module, and the controller; and
a base tag including:
   an attachment device configured to clip the tracking tag to an ear of the animal, and
   a hole configured to hold the enclosure in the base tag.

Clause 8. The tracking tag of any clause herein, wherein the enclosure includes a front side and a back side, wherein the front side mates with the back side.

Clause 9. The tracking tag of any clause herein, wherein the base tag further includes a plurality of slots in the base tag to align the enclosure to fit inside the hole in the enclosure.

Clause 10. The tracking tag any clause herein, wherein the hole in the enclosure is configured to hold the enclosure such that a longitudinal axis of the enclosure is aligned perpendicular to the attachment device.

Clause 11. The tracking tag of any clause herein, wherein the hole in the enclosure is configured to hold the enclosure such that a longitudinal axis of the enclosure is aligned to intersect the attachment device.

Clause 12. The tracking tag of any clause herein, further comprising a LoRa module.

Clause 13. The tracking tag of any clause herein, wherein the GNSS module includes a Global Positioning System (GPS) sensor.

Clause 14. The tracking tag of any clause herein, further comprising an attachment device configured to clip the tracking tag to an ear of the animal.

Clause 15. A method for animal tracking with a tracking tag comprising a Bluetooth Low Energy (BLE) module and a Global Navigation Satellite System (GNSS) module, the method comprising:
detecting, using the BLE module, that an animal is located within a zone defined by a plurality of repeater devices;
deactivating the GNSS module when the animal is detected as being within the zone; detecting, using the BLE module, that the animal is not located within the zone; and activating the GNSS module when the animal is detected as not being within the zone.

Clause 16. The method of any clause herein, further comprising clipping the tracking tag to an ear of the animal.

Clause 17. The method of any clause herein, further comprising:
measuring movement data of the animal with one or more sensors of the tracking tag; and
determining one or more conditions of the animal based on the movement data of the animal.

Clause 18. A system for animal tracking, comprising:
a plurality of repeater devices; and
a tracking tag including a Bluetooth Low Energy (BLE) module and a Global Navigation Satellite System (GNSS) module, wherein the tracking tag is configured to:
   detect, using the BLE module, when an animal is located within a zone defined by one or more of the plurality of repeater devices,
   deactivate the GNSS module when the animal is detected as being within the zone, and
   activate the GNSS module when the animal is not detected as being within the zone.

Clause 19. The system of any clause herein, wherein the tracking tag further includes one or more sensors for measuring movement data of the animal, wherein the system further comprises a server configured to determine one or more conditions of the animal based on the movement data of the animal, and wherein the BLE module is configured to send the movement data of the animal to the server.

Clause 20. The system of any clause herein, wherein the BLE module is further configured to send the movement data of the animal to the server via one or more of the plurality of repeater devices.

Many of the electrical connections in the drawings are shown as direct couplings having no intervening devices, but not expressly stated as such in the description above. Nevertheless, this paragraph shall serve as antecedent basis in the claims for referencing any electrical connection as “directly coupled” for electrical connections shown in the drawing with no intervening device(s).

The above discussion is meant to be illustrative of the principles and various implementations of the present invention. Numerous variations and modifications will become apparent to those skilled in the art once the above disclosure is fully appreciated. It is intended that the following claims be interpreted to embrace all such variations and modifications.

What is claimed is:

1. A tracking tag for animal tracking, comprising:
a Bluetooth Low Energy (BLE) module;
a Global Navigation Satellite System (GNSS) module; and
a controller configured to:
detect, using the BLE module, when an animal is located within a zone defined by one or more repeater devices,
deactivate the GNSS module when the animal is detected as being within the zone, and
activate the GNSS module when the animal is not detected as being within the zone.

2. The tracking tag of claim 1, further comprising one or more sensors for measuring movement data of the animal, wherein the controller is further configured to determine one or more conditions of the animal based on the movement data of the animal.

3. The tracking tag of claim 1, further comprising:
a solar collector configured to convert incident light into energy; and
a power module configured to store the energy and provide the energy to the BLE module, the GNSS module, and the controller.

4. The tracking tag of claim 3, further comprising an enclosure housing the BLE module, the GNSS module, the controller, the power module, and the solar collector, wherein the enclosure includes a window positioned over the solar collector, wherein the window includes a polycarbonate material with a scratch resist coating.

5. The tracking tag of claim 1, further comprising an enclosure housing the BLE module, the GNSS module, and the controller, wherein the enclosure including a front side and a back side, wherein the front side is configured to mate with the back side to waterproof the enclosure.

6. The tracking tag of claim 5, further comprising a reset button coupled to the controller, wherein the reset button is positioned within the enclosure such that the reset button is pressed when a portion of the enclosure is pressed.

7. The tracking tag of claim 1, further comprising:
an enclosure housing the BLE module, the GNSS module, and the controller; and
a base tag including:
an attachment device configured to clip the tracking tag to an ear of the animal, and a hole configured to hold the enclosure in the base tag.

8. The tracking tag of claim 7, wherein the enclosure includes a front side and a back side, wherein the front side mates with the back side.

9. The tracking tag of claim 8, wherein the base tag further includes a plurality of slots in the base tag to align the enclosure to fit inside the hole in the enclosure.

10. The tracking tag claim 7, wherein the hole in the enclosure is configured to hold the enclosure such that a longitudinal axis of the enclosure is aligned perpendicular to the attachment device.

11. The tracking tag of claim 7, wherein the hole in the enclosure is configured to hold the enclosure such that a longitudinal axis of the enclosure is aligned to intersect the attachment device.

12. The tracking tag of claim 1, further comprising a LoRa module.

13. The tracking tag of claim 1, wherein the GNSS module includes a Global Positioning System (GPS) sensor.

14. The tracking tag of claim 1, further comprising an attachment device configured to clip the tracking tag to an ear of the animal.

15. A method for animal tracking with a tracking tag comprising a Bluetooth Low Energy (BLE) module and a Global Navigation Satellite System (GNSS) module, the method comprising:
detecting, using the BLE module, that an animal is located within a zone defined by a plurality of repeater devices;
deactivating the GNSS module when the animal is detected as being within the zone;
detecting, using the BLE module, that the animal is not located within the zone; and
activating the GNSS module when the animal is detected as not being within the zone.

16. The method of claim 15, further comprising clipping the tracking tag to an ear of the animal.

17. The method of claim 15, further comprising:
measuring movement data of the animal with one or more sensors of the tracking tag; and
determining one or more conditions of the animal based on the movement data of the animal.

18. A system for animal tracking, comprising:
a plurality of repeater devices; and
a tracking tag including a Bluetooth Low Energy (BLE) module and a Global Navigation Satellite System (GNSS) module, wherein the tracking tag is configured to:
detect, using the BLE module, when an animal is located within a zone defined by one or more of the plurality of repeater devices,
deactivate the GNSS module when the animal is detected as being within the zone, and
activate the GNSS module when the animal is not detected as being within the zone.

19. The system of claim 18, wherein the tracking tag further includes one or more sensors for measuring movement data of the animal, wherein the system further comprises a server configured to determine one or more conditions of the animal based on the movement data of the animal, and wherein the BLE module is configured to send the movement data of the animal to the server.

20. The system of claim 19, wherein the BLE module is further configured to send the movement data of the animal to the server via one or more of the plurality of repeater devices.
